(19) United States
(12) Patent Application Publication
(10) Pub. No.: US 2026/0288447 A1
(43) Pub. Date: Sep. 24, 2026

(54) SOFTWARE UPDATE DEVICE, SOFTWARE UPDATE METHOD, AND STORAGE MEDIUM

(71) Applicant: HONDA MOTOR CO., LTD., Tokyo (JP)

(72) Inventors: Yujiro Komiyama, Tokyo (JP); Yasumasa Kaitani, Tokyo (JP)

(21) Appl. No.: 19/555,020

(22) Filed: Mar. 3, 2026

(30) Foreign Application Priority Data
Mar. 19, 2025 (JP) 2025-045465

(51) Int. Cl. G06F 8/65

(52) U.S. Cl. CPC G06F 8/65

(57) ABSTRACT

A software update device includes: a communication unit; a storage unit; a software obtaining unit; and a software update unit. The software obtaining unit is configured to execute software obtaining processing of downloading pieces of new version software of a plurality of control devices in series from a software providing device through the communication unit and storing the pieces of new version software in the storage unit. The plurality of control devices is mounted on a mobile object. The software update unit is configured to execute first software update processing of installing the pieces of new version software for which storage in the storage unit is completed in the corresponding control devices and deleting the pieces of new version software for which installation is completed from the storage unit while the software obtaining processing is being executed.

### INCORPORATION BY REFERENCE

The present application claims priority under 35 U.S.C. § 119 to Japanese Patent Application No. 2025-045465 filed on Mar. 19, 2025. The content of the application is incorporated herein by reference in its entirety.

### BACKGROUND OF THE INVENTION

### Field of the Invention

The present invention relates to a software update device, a software update method, and a storage medium.

### Description of the Related Art

A technology that supports the update of software in a control device mounted on a mobile object such as a vehicle has been conventionally proposed. For example, Japanese Patent Laid-Open No. 2020-132026 discloses a software update device that updates pieces of software of a plurality of control devices mounted on a vehicle by selecting any of a parallel update mode and a serial update mode. In the parallel update mode, pieces of software are updated for a plurality of electronic control devices in parallel. In the serial update mode, pieces of software are updated for a plurality of electronic control devices in series.

The pieces of software of the plurality of control devices mounted on the mobile object are updated by storing pieces of new version software downloaded from a support server or the like in a storage unit and then installing the pieces of new version software stored in the storage unit in the respective control devices. The pieces of downloaded new version software therefore have a large amount of data depending on the number of control devices or the specifications of pieces of software used in the control devices. The installation of a storage unit having capacity necessary to store the pieces of downloaded new version software then disadvantageously increases the size of the storage unit and also increases the cost of the storage unit.

This application has been devised in view of the background described above. An object of this application is to provide a software update device, a software update method, and a storage medium that each make it possible to reduce the capacity of a storage unit used to update pieces of software of a plurality of control devices included in a mobile object.

### SUMMARY OF THE INVENTION

A first aspect for achieving the object includes a software update device including: a communication unit; a storage unit; a software obtaining unit; and a software update unit. The software obtaining unit is configured to execute software obtaining processing of downloading pieces of new version software of a plurality of control devices in series from a software providing device through the communication unit and storing the pieces of new version software in the storage unit. The plurality of control devices is mounted on a mobile object. The software update unit is configured to execute first software update processing of installing the pieces of new version software for which storage in the storage unit is completed in the corresponding control devices and deleting the pieces of new version software for which installation is completed from the storage unit while the software obtaining processing is being executed.

The software update device may have a configuration in which the plurality of control devices includes a plurality of first control devices and a plurality of second control devices. The software obtaining unit executes, as the software obtaining processing, first software obtaining processing of downloading pieces of new version software of a plurality of the first control devices in series from the software providing device through the communication unit and storing the pieces of new version software in a first region of the storage unit and second software obtaining processing of downloading pieces of new version software of a plurality of the second control devices in series from the software providing device through the communication unit and storing the pieces of new version software in a second region of the storage unit. The software update unit executes, as the first software update processing, processing of installing the pieces of new version software of the first control devices for which storage in the first region of the storage unit is completed in the corresponding first control devices and deleting the pieces of new version software of the first control devices for which installation is completed from the first region of the storage unit while the first software obtaining processing is being executed and executes second software update processing of installing the pieces of new version software of the second control devices stored in the second region of the storage unit in the corresponding second control devices after the second software obtaining processing is completed.

The software update device may have a configuration in which the first control devices each execute control that is not relevant to movement of the mobile object. The second control devices each execute control that is relevant to the movement of the mobile object.

A second aspect for achieving the object includes a software update method that is executed by a computer. The software update method includes: a software obtaining step; and a software update step. In the software obtaining step, software obtaining processing of downloading pieces of new version software of a plurality of control devices in series from a software providing device through a communication unit and storing the pieces of new version software in a storage unit is executed. The plurality of control devices is mounted on a mobile object. In the software update step, first software update processing of installing the pieces of new version software for which storage in the storage unit is completed in the corresponding control devices and deleting the pieces of new version software for which installation is completed from the storage unit is executed while the software obtaining processing is being executed.

A third aspect for achieving the object includes a non-transitory computer readable storage medium storing a program that causes a computer to function as a software obtaining unit, and a software update unit. The software obtaining unit is configured to execute software obtaining processing of downloading pieces of new version software of a plurality of control devices in series from a software providing device through a communication unit and storing the pieces of new version software in a storage unit. The plurality of control devices is included in a mobile object. The software update unit is configured to execute first software update processing of installing the pieces of new version software for which storage in the storage unit is completed in the corresponding control devices and deleting the pieces of new version software for which installation is completed from the storage unit while the software obtaining processing is being executed.

The software update device, the software update method, and the storage medium each make it possible to reduce the capacity of a storage unit used to update pieces of software of a plurality of control devices included in a mobile object.

### BRIEF DESCRIPTION OF THE DRAWINGS

FIG. 1 is a configuration diagram of a software update device;

FIG. 2 is a flowchart of software update processing on a first local ECU;

FIG. 3 is an explanatory diagram showing how software of the first local ECU is downloaded and installed;

FIG. 4 is a flowchart of software update processing on a second local ECU; and

FIG. 5 is an explanatory diagram showing how software of the second local ECU is downloaded and installed.

### DETAILED DESCRIPTION OF THE INVENTION

### 1. Configuration of Software Update Device

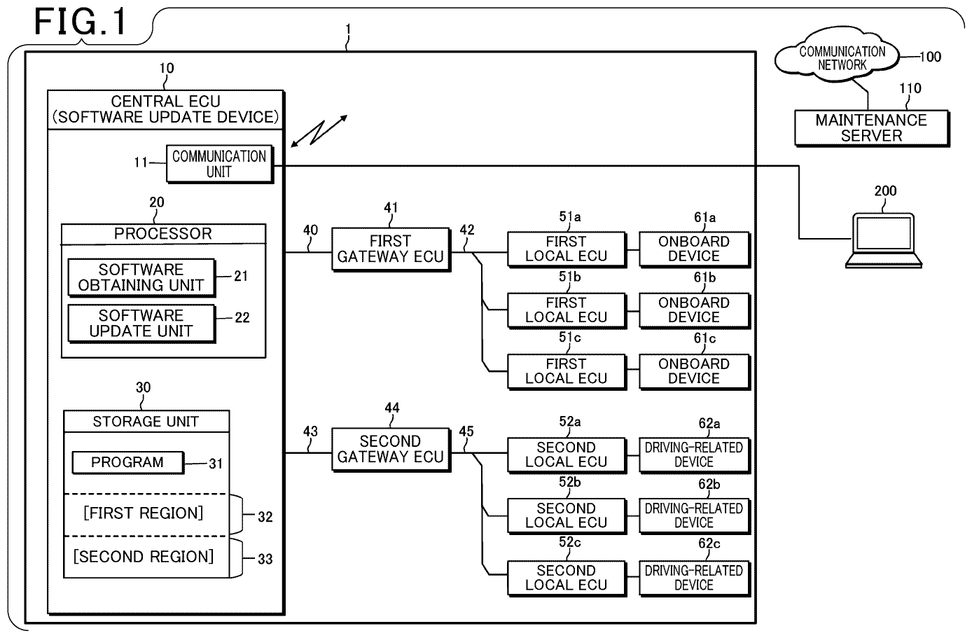

The configuration of a software update device according to the present embodiment will be described with reference to FIG. 1. The software update device according to the present embodiment is configured as some of the functions of a central ECU (Electronic Control Unit) 10 mounted on a vehicle 1. The vehicle 1 corresponds to a mobile object according to the present disclosure.

The central ECU 10 includes a communication unit 11 (transmitter/receiver, circuit). The central ECU 10 communicates with a maintenance server 110 (computer) through the communication unit 11 via a communication network 100. In addition, the central ECU 10 is connected to a maintenance terminal 200 and communicates with the maintenance terminal 200. The maintenance server 110 and the maintenance terminal 200 each correspond to a software providing device according to the present disclosure. The central ECU 10 is connected to a first gateway ECU 41 by a communication line 40 and connected to a second gateway ECU 44 by a communication line 43.

The first gateway ECU 41 is connected to three first local ECUs 51a to 51c by a communication line 42 and the second gateway ECU 44 is connected to three second local ECUs 52a to 52c by a communication line 45. The first local ECUs 51a to 51c are respectively connected to onboard devices 61a to 61c and the second local ECUs 52a to 52c are respectively connected to driving-related devices 62a to 62c.

The following generically refers to the first local ECUs 51a to 51c as first local ECUs 51 and generically refers to the onboard devices 61a to 61c as onboard devices 61. In addition, the second local ECUs 52a to 52c will be generically referred to as second local ECUs 52 and the driving-related devices 62a to 62c will be generically referred to as driving-related devices 62. The first local ECUs 51 each correspond to a control device and a first control device according to the present disclosure and the second local ECUs 52 each correspond to the control device and a second control device according to the present disclosure.

The onboard devices 61 are devices such as an audio device, an air conditioner, and a seat heater that are not relevant to the traveling (movement) of the vehicle 1. The first local ECUs 51 each control the actuation of the onboard device 61. Each of the driving-related devices 62 is a device relevant to the traveling of the vehicle 1 such as driving, braking, or steering the vehicle 1. Each of the second local ECUs 52 controls the actuation of the driving-related device 62. It is to be noted that the two or less or four or more first local ECUs 51 and second local ECUs 52 may be adopted.

The central ECU 10 supports the maintenance of the vehicle 1 via OTA (Over The Air) through communication with the maintenance server 110. In the present embodiment, processing will be described that updates pieces of software stored in the first local ECU 51 and the second local ECU 52 by causing the central ECU 10 to download pieces of new version software of the first local ECU 51 and the second local ECU 52 from the maintenance server 110 and install the respective pieces of new version software in the first local ECU 51 and the second local ECU 52. It is to be noted that the pieces of new version software of the first local ECU 51 and the second local ECU 52 may be downloaded from the maintenance terminal 200.

The central ECU 10 includes a communication unit 11, a processor 20, a storage unit 30, and the like. A program 31 for controlling the central ECU 10 is stored in the storage unit 30. In addition, a first region 32 and a second region 33 are allocated in the storage unit 30. The first region 32 is for storing the pieces of new version software of the first local ECUs 51. The second region 33 is for storing the pieces of new version software of the second local ECUs 52.

The processor 20 corresponds to a computer according to the present disclosure. The processor 20 reads and executes the program 31 to function as a software obtaining unit 21 and a software update unit 22. The software obtaining unit 21 executes first software obtaining processing of downloading the pieces of new version software of the plurality of first local ECUs 51 in series through communication with the maintenance server 110 or the maintenance terminal 200 and storing the pieces of new version software in the first region 32 of the storage unit 30 and second software obtaining processing of downloading the pieces of new version software of the plurality of second local ECUs 52 in series through communication with the maintenance server 110 or the maintenance terminal 200 and storing the pieces of new version software in the second region 33 of the storage unit 30.

The software update unit 22 executes first software update processing of installing the pieces of new version software of the first local ECUs 51 stored in the first region 32 in the first local ECUs 51 and updating the pieces of software stored in the first local ECUs 51. In addition, the software update unit 22 executes second software update processing of installing the pieces of new version software of the second local ECUs 52 stored in the second region 33 in the second local ECUs 52 and updating the pieces of software stored in the second local ECUs 52. The details of the first software update processing and the second software update processing will be described below.

Processing executed by the software obtaining unit 21 corresponds to a software obtaining step of a software update method according to the present disclosure and processing executed by the software update unit 22 corresponds to a software update step of the software update method according to the present disclosure.

### 2. Software Update Processing on First Local ECUs

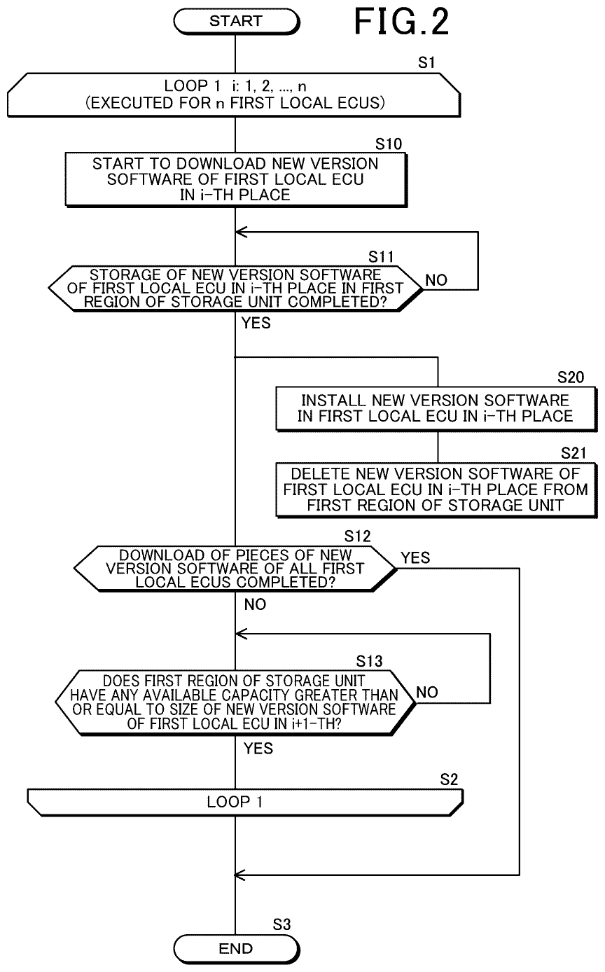

Procedures of software update processing executed by the central ECU 10 on the first local ECUs 51 will be described with reference to the flowchart illustrated in FIG. 2. The central ECU 10 executes the processing of a loop 1 of steps S1 to S2 of FIG. 2 to update the pieces of software stored in the plurality of first local ECUs 51.

Steps S10 to S13 of FIG. 2 are the first software obtaining processing to be executed by the software obtaining unit 21. In step S10, the software obtaining unit 21 starts to download the new version software of the first local ECU 51 in the i-th (i=1, 2, . . . , n) place. In the example of FIG. 1, n is equal to 3. The first local ECU 51a is in the first place, the first local ECU 51b is in the second place, and the first local ECU 51c is in the third place. The software obtaining unit 21 stores the pieces of data of the pieces of downloaded new version software of the first local ECUs 51 in the i-th place in the first region 32 of the storage unit 30 in series.

The software obtaining unit 21 advances the processing to step S12 when the storage of the new version software of the first local ECU 51 in the i-th place in the first region 32 of the storage unit 30 is completed in subsequent step S11. In addition, the software update unit 22 executes the first software update processing through steps S20 and S21 at this timing. In step S20, the software update unit 22 installs the new version software of the first local ECU 51 in the i-th place stored in the first region 32 of the storage unit 30 in the first local ECU 51 in the i-th place via the first gateway ECU 41, thereby updating the software stored in the first local ECU 51 in the i-th place. In next step S21, the software update unit 22 deletes the new version software of the first local ECU 51 in the i-th place for which the installation is completed from the first region 32 of the storage unit 30.

In step S12, the software obtaining unit 21 determines whether or not the download of the pieces of new version software is completed for all the first local ECUs 51. The software obtaining unit 21 then advances the processing to step S13 when the download of the pieces of new version software is not completed for all the first local ECUs 51. When the download of the pieces of new version software is completed, the software obtaining unit 21 breaks the loop 1 and advances the processing to step S3.

In step S13, the software obtaining unit 21 waits for the first region 32 of the storage unit 30 to have available capacity greater than or equal to the size of the new version software of the first local ECU 51 in the i+1-th place and executes the next cycle of the loop 1. According to the flowchart of FIG. 2, the first software obtaining processing by the software obtaining unit 21 in steps S10 to S13 and the first software update processing by the software update unit 22 in steps S20 and S21 are executed in parallel as described above.

This immediately deletes the new version software of the first local ECU 51 in the i-th place for which the installation is completed from the first region 32 of the storage unit 30 and stores the new version software of the first local ECU 51 in the i+1-th place in the region made available by the deletion in the first region 32.

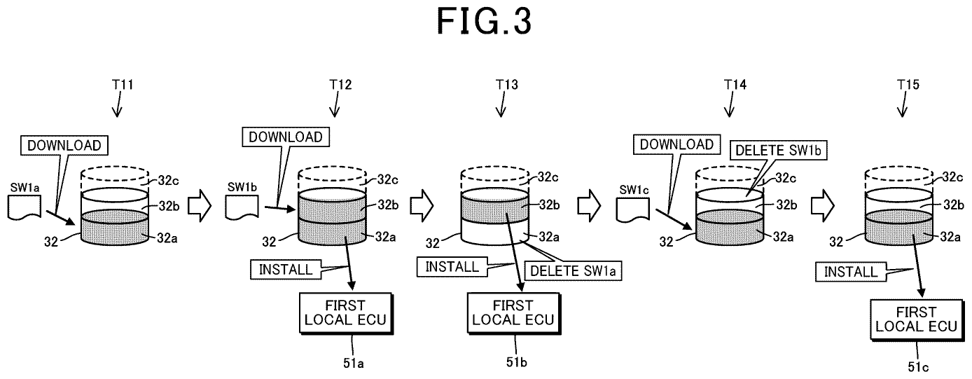

Here, it will be described with reference to FIG. 3 how the first region 32 of the storage unit 30 is used for the three first local ECUs 51a to 51c illustrated in FIG. 1 when the software update processing is executed on the first local ECUs 51 in accordance with the flowchart illustrated in FIG. 2. FIG. 3 illustrates a situation in which the first region 32 of the storage unit 30 is divided into a first sub-region 32a and a second sub-region 32b for use. A third sub-region 32c is virtually illustrated as a sub-region that is actually unnecessary.

At T11 of FIG. 3, the software obtaining unit 21 downloads new version software SW1a of the first local ECU 51a in the first place and stores the new version software SW1a in the first sub-region 32a. At subsequent T22, the software obtaining unit 21 downloads new version software SW1b of the first local ECU 51b in the second place and stores new version software SW1b in the second sub-region 32b. In addition, the software update unit 22 executes processing of installing the new version software SW1a for which the storage in the first sub-region 32a is completed in the first local ECU 51a in the first place at the same timing in parallel.

At subsequent T13, the software update unit 22 deletes the new version software SW1a for which the installation is completed from the first sub-region 32a. In addition, the software update unit 22 installs the new version software SW1b for which the storage in the second sub-region 32b is completed in the first local ECU 51b in the second place.

At subsequent T14, the software obtaining unit 21 downloads new version software SW1c of the first local ECU 51c in the third place and stores the new version software SW1c in the first sub-region 32a made available by the deletion at T13. In addition, the software update unit 22 deletes the new version software SW1b for which the installation in the first local ECU 51b in the second place is completed from the second sub-region 32b.

At subsequent T15, the software update unit 22 installs the new version software SW1c for which the storage in the first sub-region 32a is completed in the first local ECU 51c in the third place.

As illustrated in FIG. 3, the execution of the software update processing on the first local ECUs 51 illustrated in FIG. 2 makes it possible to execute the software update processing on the three first local ECUs 51a to 51c using the first sub-region 32a and the second sub-region 32b for two first local ECUs. This eliminates the necessity to secure the third sub-region 32c corresponding to the first local ECU in the third place and makes it possible to reduce the capacity of the first region 32.

### 3. Software Update Processing on Second Local ECUs

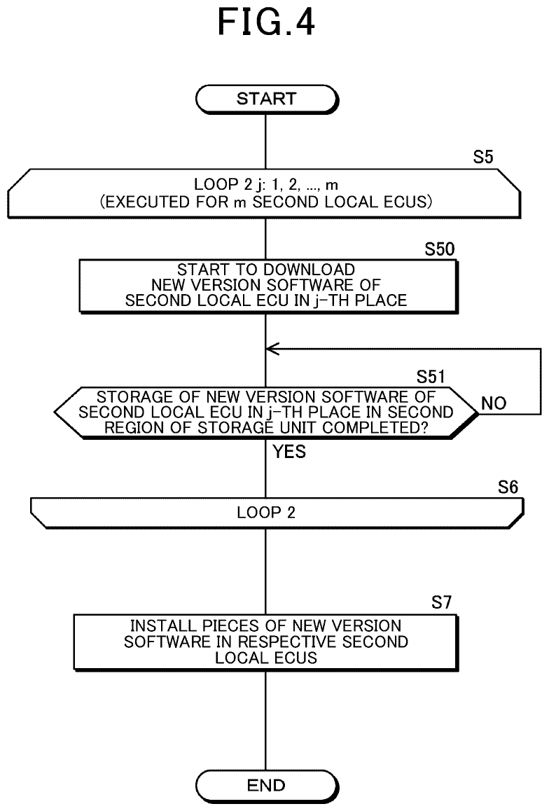

Procedures of software update processing executed by the central ECU 10 on the second local ECUs 52 will be described with reference to the flowchart illustrated in FIG. 4. The central ECU 10 executes the processing of a loop 2 of steps S5 to S6 of FIG. 3 and the processing of step S7 to update the pieces of software stored in the plurality of second local ECUs 52.

The loop 2 of steps S5 to S6 of FIG. 4 is the second software obtaining processing by the software obtaining unit 21. In step S50, the software obtaining unit 21 starts to download the new version software of the second local ECU 52 in the j-th (j=1, 2, . . . , m) place. In the example of FIG. 1, m is equal to 3. The second local ECU 52a is in the first place, the second local ECU 52b is in the second place, and the second local ECU 52c is in the third place. The software obtaining unit 21 stores the pieces of downloaded new version software of the second local ECUs 52 in the j-th place in the second region 33 of the storage unit 30 in series.

The software obtaining unit 21 advances the processing to the next cycle of the loop 2 when the storage of the new version software of the second local ECU 52 in the j-th place in the second region 33 of the storage unit 30 is completed in subsequent step S51. The software obtaining unit 21 breaks the loop 2 and advances the processing to step S7 when the processing up to the second local ECU 52 in the m-th place is completed.

Step S7 is the second software update processing by the software update unit 22. The software update unit 22 installs the pieces of new version software stored in the second region 33 of the storage unit 30 in the respective corresponding second local ECUs 52 via the second gateway ECU 44 through the processing of the loop 2 described above, thereby updating the pieces of software stored in the respective second local ECUs 52.

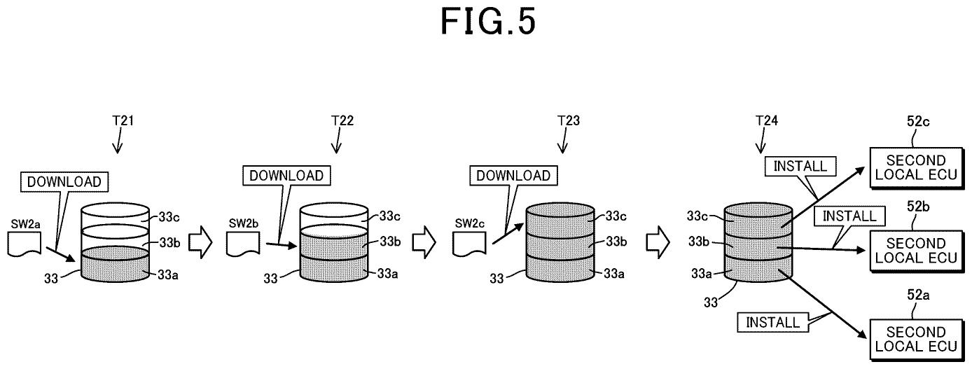

Here, it will be described with reference to FIG. 5 how the second region 33 of the storage unit 30 is used for the three second local ECUs 52a to 52c illustrated in FIG. 1 when the software update processing is executed on the second local ECUs 52 in accordance with the flowchart illustrated in FIG. 4. FIG. 5 illustrates a situation in which the second region 33 of the storage unit 30 is divided into a first sub-region 33a, a second sub-region 33b, and a third sub-region 33c for use.

At T21 of FIG. 5, the software obtaining unit 21 downloads new version software SW2a of the second local ECU 52a in the first place and stores the new version software SW2a in the first sub-region 33a. At subsequent T22, the software obtaining unit 21 downloads new version software SW2b of the second local ECU 52b in the second place and stores new version software SW2b in the second sub-region 33b.

At subsequent T23, the software obtaining unit 21 downloads new version software SW2c of the second local ECU 52c in the third place and stores new version software SW2c in the third sub-region 33c. At subsequent T24, the software update unit 22 installs the new version software SW2a stored in the first sub-region 33a in the second local ECU 52a in the first place via the second gateway ECU 44, thereby updating the software stored in the second local ECU 52a in the first place.

Similarly, the software update unit 22 installs the new version software SW2b stored in the second sub-region 33b in the second local ECU 52b in the second place via the second gateway ECU 44, thereby updating the software stored in the second local ECU 52b in the second place. In addition, the software update unit 22 installs the new version software SW2c stored in the third sub-region 33c in the second local ECU 52c in the third place via the second gateway ECU 44, thereby updating the software stored in the second local ECU 52c in the third place.

As illustrated in FIG. 5, in a case where the software update processing is executed on the second local ECUs 52 illustrated in FIG. 4, it is necessary to secure the second region 33 capacity for storing the pieces of new version software of the three second local ECUs 52a to 52c. The necessary capacity of the second region 33 is therefore greater than the capacity of the first region 32. The pieces of new version software are, however, downloaded and installed separately, thereby making it possible to increase the reliability of the processing of updating the pieces of software stored in the second local ECUs 52. The second local ECUs 52 are ECUs that each control the driving-related device 62. It is therefore effective to increase the reliability of the processing of updating the pieces of software in this way.

### 4. Other Embodiments

In the embodiment, the vehicle 1 has been exemplified as the mobile object according to the present disclosure. The mobile object according to the present disclosure may be an aircraft, a vessel, or the like.

In the embodiment, the pieces of software have been updated for the plurality of first local ECUs 51 through the processing compliant with the flowchart illustrated in FIG. 2 and the pieces of software have been updated for the plurality of second local ECUs 52 through the processing compliant with the flowchart illustrated in FIG. 4. As another embodiment, the pieces of software may be updated for all the local ECUs through the processing compliant with the flowchart illustrated in FIG. 2.

In the embodiment, the ECUs that control the onboard devices 61 which are not relevant to the traveling of the vehicle 1 have been described as the first local ECUs 51 (each corresponding to the first control device according to the present disclosure) and the ECUs that control the driving-related devices 62 which are relevant to the traveling of the vehicle 1 have been described as the second local ECUs 52 (each corresponding to the second control device according to the present disclosure). As another embodiment, the first control devices and the second control devices according to the present disclosure may be distinguished using another element.

It is to be noted that FIG. 1 is a schematic diagram in which the configuration of the software update device according to the present disclosure is divided in accordance with the chief processing contents for facilitating the understandings of the invention according to this application, but the software update device may be configured in accordance with other division. In addition, the processing of each of the components may be executed by one hardware unit or executed by a plurality of hardware units. In addition, the processing by each of the components illustrated in FIGS. 2 and 4 may be executed by one program or executed by a plurality of programs.

### 4. Configurations Supported by Embodiments Above

The embodiments are specific examples of the following configurations.

(Configuration 1) A software update device including: a communication unit; a storage unit; a software obtaining unit configured to execute software obtaining processing of downloading pieces of new version software of a plurality of control devices in series from a software providing device through the communication unit and storing the pieces of new version software in the storage unit, the plurality of control devices being mounted on a mobile object; and a software update unit configured to execute first software update processing of installing the pieces of new version software for which storage in the storage unit is completed in the corresponding control devices and deleting the pieces of new version software for which installation is completed from the storage unit while the software obtaining processing is being executed.

The software update device according to Configuration 1 makes it possible to reduce the capacity of the storage unit used to update the pieces of software of the plurality of control devices included in the mobile object.

(Configuration 2) The software update device according to Configuration 1, in which the plurality of control devices includes a plurality of first control devices and a plurality of second control devices, the software obtaining unit executes, as the software obtaining processing, first software obtaining processing of downloading pieces of new version software of a plurality of the first control devices in series from the software providing device through the communication unit and storing the pieces of new version software in a first region of the storage unit and second software obtaining processing of downloading pieces of new version software of a plurality of the second control devices in series from the software providing device through the communication unit and storing the pieces of new version software in a second region of the storage unit, and the software update unit executes, as the first software update processing, processing of installing the pieces of new version software of the first control devices for which storage in the first region of the storage unit is completed in the corresponding first control devices and deleting the pieces of new version software of the first control devices for which installation is completed from the first region of the storage unit while the first software obtaining processing is being executed and executes second software update processing of installing the pieces of new version software of the second control devices stored in the second region of the storage unit in the corresponding second control devices after the second software obtaining processing is completed.

The software update device according to Configuration 2 makes it possible to update the pieces of software for the plurality of control devices included in the mobile object while distinguishing the first control devices subjected to the first software update processing to prioritize a reduction in the capacity of a storage device and the second control devices subjected to the second software update processing to prioritize the reliability of updating the pieces of software.

(Configuration 3) The software update device according to Configuration 2, in which the first control devices each execute control that is not relevant to movement of the mobile object, and the second control devices each execute control that is relevant to the movement of the mobile object.

The software update device according to Configuration 3 makes it possible to execute the first software update processing of allowing the capacity of the storage unit to be reduced for the first control devices that each execute the control which is not relevant to the movement of the mobile object and execute the second software update processing of allowing the reliability to be increased for the second control devices that each execute the control which is relevant to the movement of the mobile object.

(Configuration 4) A software update method that is executed by a computer, the software update method including: a software obtaining step of executing software obtaining processing of downloading pieces of new version software of a plurality of control devices in series from a software providing device through a communication unit and storing the pieces of new version software in a storage unit, the plurality of control devices being mounted on a mobile object; and a software update step of executing first software update processing of installing the pieces of new version software for which storage in the storage unit is completed in the corresponding control devices and deleting the pieces of new version software for which installation is completed from the storage unit while the software obtaining processing is being executed.

The execution of the software update method according to Configuration 4 by the computer makes it possible to obtain the workings and effects similar to those of the software update device according to Configuration 1.

(Configuration 5) A non-transitory computer readable storage medium storing a program that causes a computer to function as a software obtaining unit configured to execute software obtaining processing of downloading pieces of new version software of a plurality of control devices in series from a software providing device through a communication unit and storing the pieces of new version software in a storage unit, the plurality of control devices being included in a mobile object, and a software update unit configured to execute first software update processing of installing the pieces of new version software for which storage in the storage unit is completed in the corresponding control devices and deleting the pieces of new version software for which installation is completed from the storage unit while the software obtaining processing is being executed.

The execution of the program of the storage medium according to Configuration 5 by the computer makes it possible to implement the configuration of the software update device according to Configuration 1.

### Reference Signs List

1 vehicle (mobile object)
10 central ECU (software update device)
11 communication unit
20 processor
21 software obtaining unit
22 software update unit
30 storage unit
31 program
32 first region
33 second region
41 first gateway ECU
44 second gateway ECU
51a to 51c first local ECU (first control device)
52a to 52c second local ECU (second control device)
61a to 61c onboard device
62a to 62c driving-related device
100 communication network
110 maintenance server (software providing device)
200 maintenance terminal (software providing device)

1. A software update device comprising:
a communication unit;
a storage unit;
a software obtaining unit configured to execute software obtaining processing of downloading pieces of new version software of a plurality of control devices in series from a software providing device through the communication unit and storing the pieces of new version software in the storage unit, the plurality of control devices being mounted on a mobile object; and
a software update unit configured to execute first software update processing of installing the pieces of new version software for which storage in the storage unit is completed in the corresponding control devices and deleting the pieces of new version software for which installation is completed from the storage unit while the software obtaining processing is being executed.

2. The software update device according to claim 1, wherein
the plurality of control devices includes a plurality of first control devices and a plurality of second control devices,
the software obtaining unit executes, as the software obtaining processing, first software obtaining processing of downloading pieces of new version software of a plurality of the first control devices in series from the software providing device through the communication unit and storing the pieces of new version software in a first region of the storage unit and second software obtaining processing of downloading pieces of new version software of a plurality of the second control devices in series from the software providing device through the communication unit and storing the pieces of new version software in a second region of the storage unit, and
the software update unit executes, as the first software update processing, processing of installing the pieces of new version software of the first control devices for which storage in the first region of the storage unit is completed in the corresponding first control devices and deleting the pieces of new version software of the first control devices for which installation is completed from the first region of the storage unit while the first software obtaining processing is being executed and executes second software update processing of installing the pieces of new version software of the second control devices stored in the second region of the storage unit in the corresponding second control devices after the second software obtaining processing is completed.

3. The software update device according to claim 2, wherein
the first control devices each execute control that is not relevant to movement of the mobile object, and
the second control devices each execute control that is relevant to the movement of the mobile object.

4. A software update method that is executed by a computer, the software update method comprising:
a software obtaining step of executing software obtaining processing of downloading pieces of new version software of a plurality of control devices in series from a software providing device through a communication unit and storing the pieces of new version software in a storage unit, the plurality of control devices being mounted on a mobile object; and
a software update step of executing first software update processing of installing the pieces of new version software for which storage in the storage unit is completed in the corresponding control devices and deleting the pieces of new version software for which installation is completed from the storage unit while the software obtaining processing is being executed.

5. A non-transitory computer readable storage medium storing a program that causes a computer to function as
a software obtaining unit configured to execute software obtaining processing of downloading pieces of new version software of a plurality of control devices in series from a software providing device through a communication unit and storing the pieces of new version software in a storage unit, the plurality of control devices being included in a mobile object, and
a software update unit configured to execute first software update processing of installing the pieces of new version software for which storage in the storage unit is completed in the corresponding control devices and deleting the pieces of new version software for which installation is completed from the storage unit while the software obtaining processing is being executed.
